(19) United States
(12) Patent Application Publication
(10) Pub. No.: US 2015/0113072 A1
(43) Pub. Date: Apr. 23, 2015

(54) MESSAGING AUTO-CORRECTION USING RECIPIENT FEEDBACK

(71) Applicant: International Business Machines Corporation, Armonk, NY (US)

(72) Inventors: Yuk L. Chan, Poughkeepsie, NY (US); Christopher Cramer, Troy, NY (US); Robert G. King, Longmont, CO (US); Deepti M. Naphade, Fishkill, NY (US); Jairo A. Pava, Wappingers Falls, NY (US)

(73) Assignee: International Business Machines Corporation, Armonk, NY (US)

(21) Appl. No.: 14/056,185

(22) Filed: Oct. 17, 2013

(51) Int. Cl. G06F 17/27; H04L 12/58

(52) U.S. Cl. CPC G06F 17/273; H04L 51/04
USPC 709/206

(57) ABSTRACT

Embodiments of the disclosure relate to providing auto-correction feedback in a messaging application. Embodiments include receiving a message from a sender and selecting a portion of the message for clarification. Embodiments also include creating a proposed modification to the message and transmitting the proposed modification to the message to the sender. Embodiments further include receiving a response from the sender regarding the proposed modification.

### BACKGROUND

The present disclosure relates to auto-correction in messaging applications, and more specifically, to auto-correction using recipient feedback in a messaging application.

Recently, electronic communications environments have become widely used. In particular, instantaneous electronic communication has become prevalent in today's society. Some examples of instantaneous electronic communication methods are instant messaging and short messaging service (SMS), commonly referred to as texting. These messaging environments are used in traditional computing devices and are also commonly used on mobile devices, which typically include smaller keyboards that are prone to typographical errors.

A variety of different technologies have been developed to attempt to assist typing on the small keyboard of mobile devices. However, the increased usage of these smaller keyboards and technologies has resulted in an increase in the errors made during communications. Currently, no auto-correction technology has been sufficiently able to fix all of the errors that are created by the users. In general, auto-correction technologies use a combination of algorithms and natural patterns, such as using parts of speech tagging and named entity recognition for spelling correction, statistical language models for contextual lookup, and combining timing and geometry for typing correction. However, the currently available methods are not able to sufficiently correct all of the errors created through rapid typing.

### SUMMARY

According to one embodiment, a method for providing auto-correction feedback in a messaging application including receiving, by a processor, a message from a sender. The method also includes selecting a portion of the message for clarification and creating a proposed modification to the message. The method further includes transmitting the proposed modification to the message to the sender and receiving a response from the sender regarding the proposed modification.

According to another embodiment, a computer program product for providing auto-correction feedback in a messaging application, the computer program product including a tangible storage medium readable by a processing circuit and storing instructions for execution by the processing circuit for performing a method that includes receiving, by a processor, a message from a sender. The method also includes selecting a portion of the message for clarification and creating a proposed modification to the message. The method further includes transmitting the proposed modification to the message to the sender and receiving a response from the sender regarding the proposed modification.

According to another embodiment, a method for receiving auto-correction feedback in a messaging application includes transmitting a message to a receiver. The method also includes receiving a proposed modification to a portion of the message from the receiver and determining whether to accept the proposed modification. Based on a determination that the proposed modification was accepted, the method further includes transmitting a notification of acceptance of the proposed modification to the receiver. Based on a determination that the proposed modification was not accepted, the method further includes transmitting a notification of decline of the proposed modification to the receiver.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram illustrating one example of a processing system for practice of the teachings herein.

FIG. 2 is a block diagram illustrating a communication system in accordance with an exemplary embodiment.

FIG. 3A is a flow diagram of a method for providing auto-correction feedback in a messaging application in accordance with an exemplary embodiment.

FIG. 3B is a flow diagram of a method for receiving auto-correction feedback in a messaging application in accordance with an exemplary embodiment.

FIG. 4A is an illustration of a messaging application utilizing recipient auto-correction feedback being used by a first user in accordance with an exemplary embodiment.

FIG. 4B is an illustration of a messaging application utilizing recipient auto-correction feedback being used by a second user in accordance with an exemplary embodiment.

FIG. 5A is an illustration of a messaging application utilizing recipient auto-correction feedback being used by a first user in accordance with an exemplary embodiment.

FIG. 5B is an illustration of a messaging application utilizing recipient auto-correction feedback being used by a second user in accordance with an exemplary embodiment.

FIG. 6A is an illustration of a messaging application utilizing recipient auto-correction feedback being used by a first user in accordance with an exemplary embodiment.

FIG. 6B is an illustration of a messaging application utilizing recipient auto-correction feedback being used by a second user in accordance with an exemplary embodiment.

FIG. 7A is an illustration of a messaging application utilizing recipient auto-correction feedback being used by a first user in accordance with an exemplary embodiment.

FIG. 7B is an illustration of a messaging application utilizing recipient auto-correction feedback being used by a second user in accordance with an exemplary embodiment.

FIG. 8A is an illustration of a messaging application utilizing recipient auto-correction feedback being used by a first user in accordance with an exemplary embodiment.

FIG. 8B is an illustration of a messaging application utilizing recipient auto-correction feedback being used by a second user in accordance with an exemplary embodiment.

FIG. 9A is an illustration of a messaging application utilizing recipient auto-correction feedback being used by a first user in accordance with an exemplary embodiment.

FIG. 9B is an illustration of a messaging application utilizing recipient auto-correction feedback being used by a second user in accordance with an exemplary embodiment.

FIG. 10 is an illustration of a messaging application utilizing recipient auto-correction feedback in accordance with an exemplary embodiment.

FIG. 11 is an illustration of a messaging application utilizing recipient auto-correction feedback in accordance with an exemplary embodiment.

### DETAILED DESCRIPTION

Exemplary embodiments of the disclosure include methods, systems and computer program products having a messaging application that utilizes recipient feedback for auto-correction. In many cases, the senders of messages may not catch every error made in a message that they compose because the sender may not read the entire message before sending. However, since the receiver presumably reads the entire message, the receiver is more likely to catch errors in the message made by the sender. In exemplary embodiments, a receiver of a message is able to provide feedback to the sender and the sender's auto-correction system.

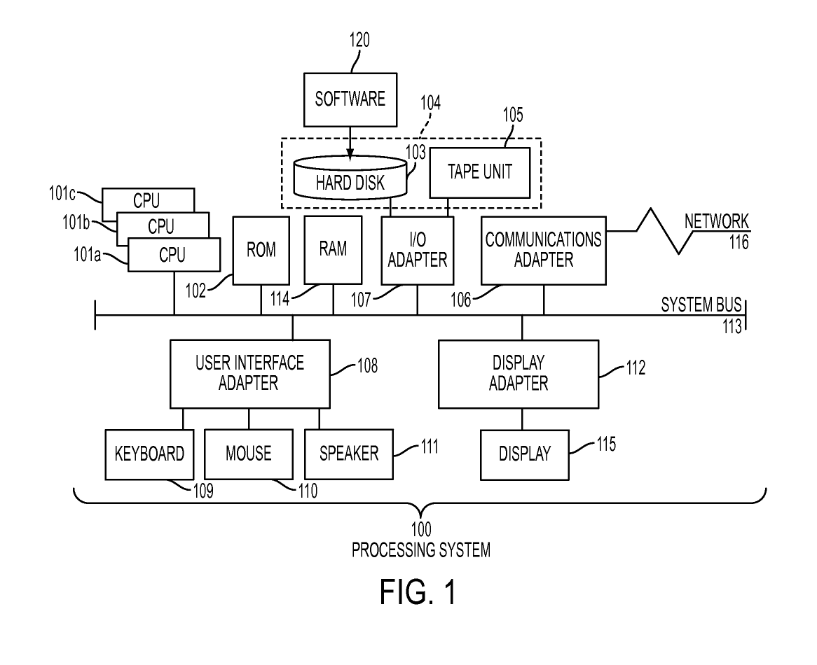

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Software 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system such as the AIX® operating system from IBM Corporation to coordinate the functions of the various components shown in FIG. 1.

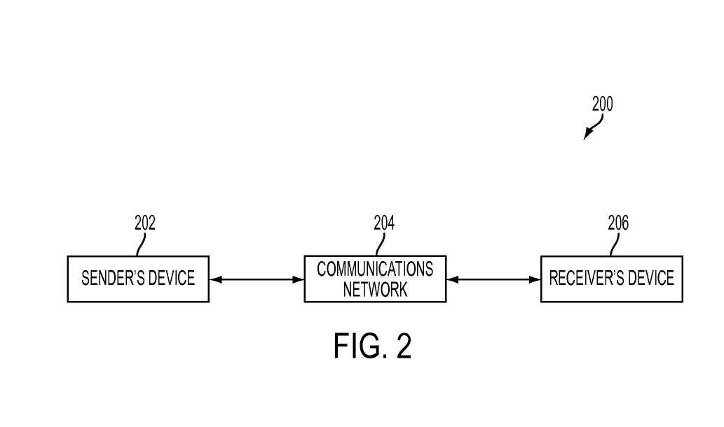

Referring now to FIG. 2, a block diagram of a communications system 200 is shown. As illustrated, the communications system 200 includes a sender's device 202, a receiver's device 204 and a communications network 204. In exemplary embodiments, the sender's device 202 and the receiver's device 204 are configured to communicate over the communications network 204. In exemplary embodiments, the sender's device 202 and receiver's device 204 may be a processing system as shown in FIG. 1, a smartphone, a tablet, or any other suitable device. In exemplary embodiments, the communications network 204 may include a cellular phone network, a local area network, a wide area network, the Internet, or the like.

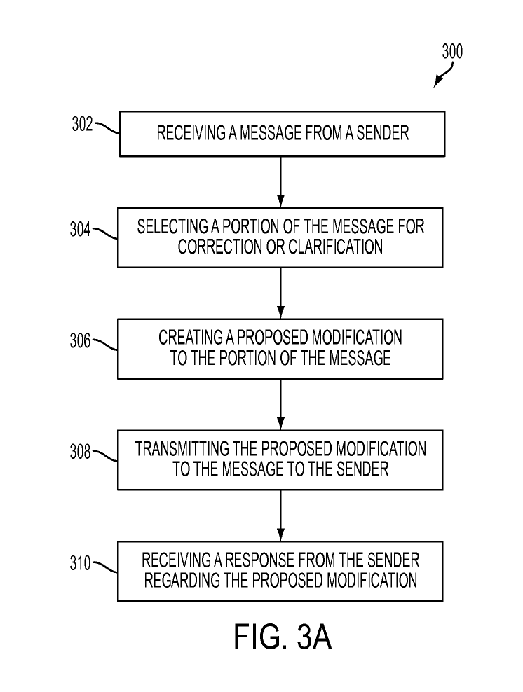

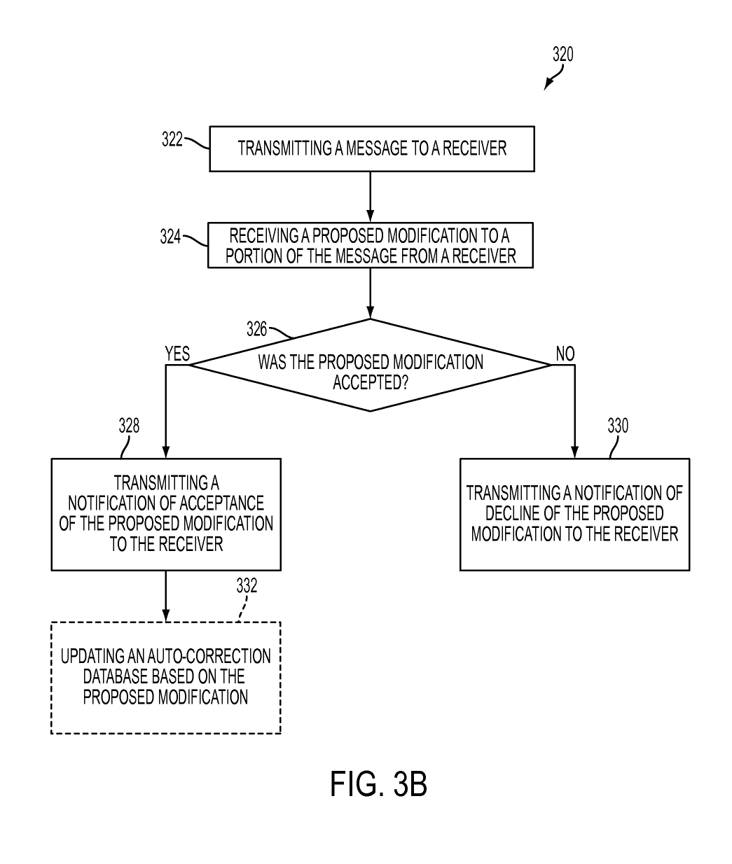

Referring now to FIG. 3A, a flow chart illustrating a method 300 for providing auto-correction feedback in a messaging application in accordance with an exemplary embodiment is shown. As shown at block 302, the method 300 includes receiving a message from a sender. Next, as shown at block 304, the method 300 includes selecting a portion of the message for correction or clarification. The method 300 also includes creating a proposed modification to the message, as shown at block 306. In exemplary embodiments, the proposed modification may be created manually or automatically using a known auto-correction technique. Next, the method 300 includes transmitting the proposed modification to the message to the sender, as shown at block 308. As shown at block 310, the method 300 includes receiving a response from the sender regarding the proposed modification. In exemplary embodiments, the sender may decide to accept, reject, or further modify the proposed modification and transmit an indication of that action to the receiver. For example, if the sender's original message included an acronym and the proposed modification included a definition of the acronym, the sender can accept, reject or modify the definition of the acronym provided by the receiver.

Referring now to FIG. 3B, a flow chart illustrating a method 320 for receiving auto-correction feedback in a messaging application in accordance with an exemplary embodiment is shown. As shown at block 322, the method 320 includes transmitting a message to a receiver. Next, as shown at block 324, the method 320 includes receiving a proposed modification to a portion of the message from the receiver. As shown at decision block 326, the method 320 includes determining if the proposed modification was accepted. If the proposed modification was accepted, the method 320 proceeds to block 328 and transmits a notification of acceptance of the proposed modification to the receiver. If the proposed modification was not accepted, the method 320 proceeds to block 330 and transmits a notification of decline of the proposed modification to the receiver. As shown at block 332, the method 320 may also include updating an auto-correction database of based on the proposed modification.

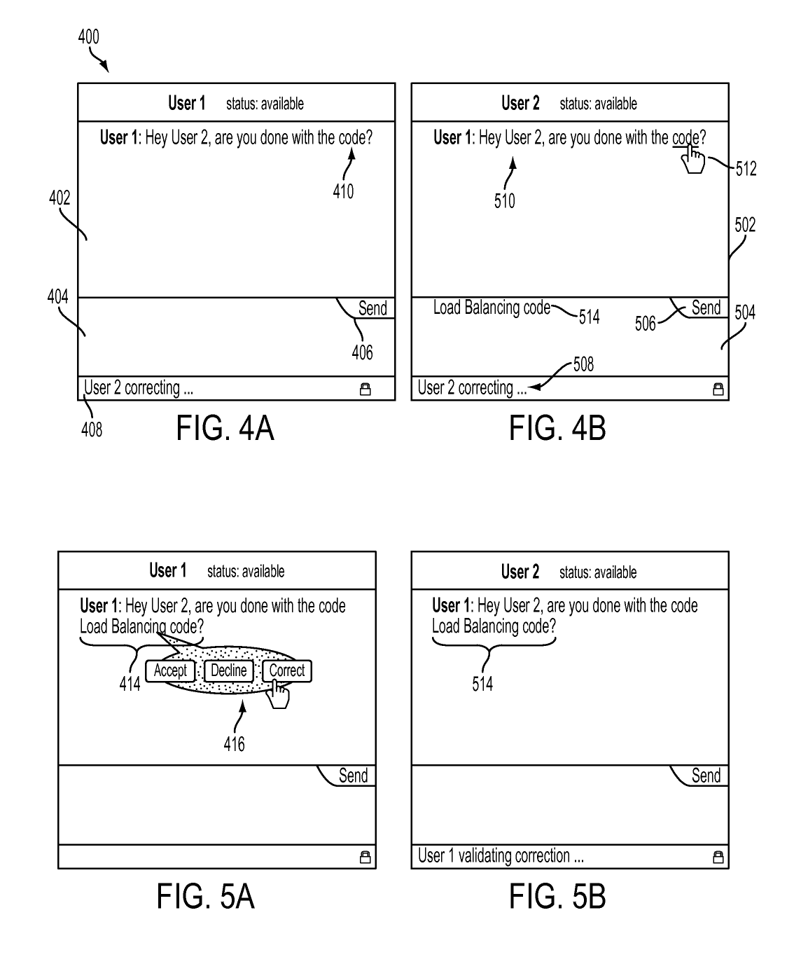

Referring now to FIGS. 4A and 4B, exemplary embodiments of a messaging application utilizing recipient auto-correction feedback being used are shown. FIG. 4A illustrates a messaging application 400 that is being used by a first user and FIG. 4B illustrates a messaging application 500 that is being used by a second user. As illustrated, the messaging application 400 includes a transcript window 402, a message composition window 404, a send button 406, and a status indicator 408. Likewise, the messaging application 500 includes a transcript window 502, a message composition window 504, a send button 506, and a status indicator 508. In exemplary embodiments, the transcript windows 402, 502 include messages that have been exchanged between the first and second users and an indication of the author or sender of each message. In exemplary embodiments, the status indicators 408, 508 are configured to provide one user with an indication of an action being taken by the other user. For example, the status indicators 408, 508 indicate that the second user is making a modification to the message 510.

Continuing with reference to FIGS. 4A and 4B, a message 410, 510 was sent from the first user to the second user. In exemplary embodiments, the second user may select a portion 512 of the message 510 that is unclear to him or her for clarification or modification. For example, the portion 512 of the message 510 may include an ambiguous word, a word that doesn't make sense in the content used, an unknown acronym, a misspelled word, or the like. After the second user selects the portion 512 of the message 510 for modification, the second user enters a proposed modification 514 in the message composition window 504. The second user then uses the send button 506 to transmit the proposed modification 514 to the first user.

Referring now to FIGS. 5A and 5B, exemplary embodiments of a messaging application utilizing recipient auto-correction feedback being used are shown. FIG. 5A illustrates the messaging application 400 that is being used by a first user and FIG. 5B illustrates the messaging application 500 that is being used by a second user. In exemplary embodiments, after the messaging application 400 receives the proposed modification 414, an indication of the proposed modification 414 may be displayed in the message 410 to the first user. For example, the proposed modification 414 may be displayed as part of the message 410 as having a different font, such as a different color or different format (e.g., italicized or underlined). Likewise, the proposed modification 514 may be displayed as part of the message 510 as having a different font, such as a different color or different format (e.g., italicized or underlined). In exemplary embodiments, an icon 416 configured to allow the first user to accept, decline, or correct the proposed modification 414 is displayed to the first user. In one embodiment, the icon 416 is displayed to the first user after the first user selects, or clicks ok, the proposed modification 414. As illustrated, the status indicators 408, 508 are configured to provide one user with an indication of an action being taken by the other user. For example, the status indicators 408, 508 indicate that the first user is reviewing the proposed modification.

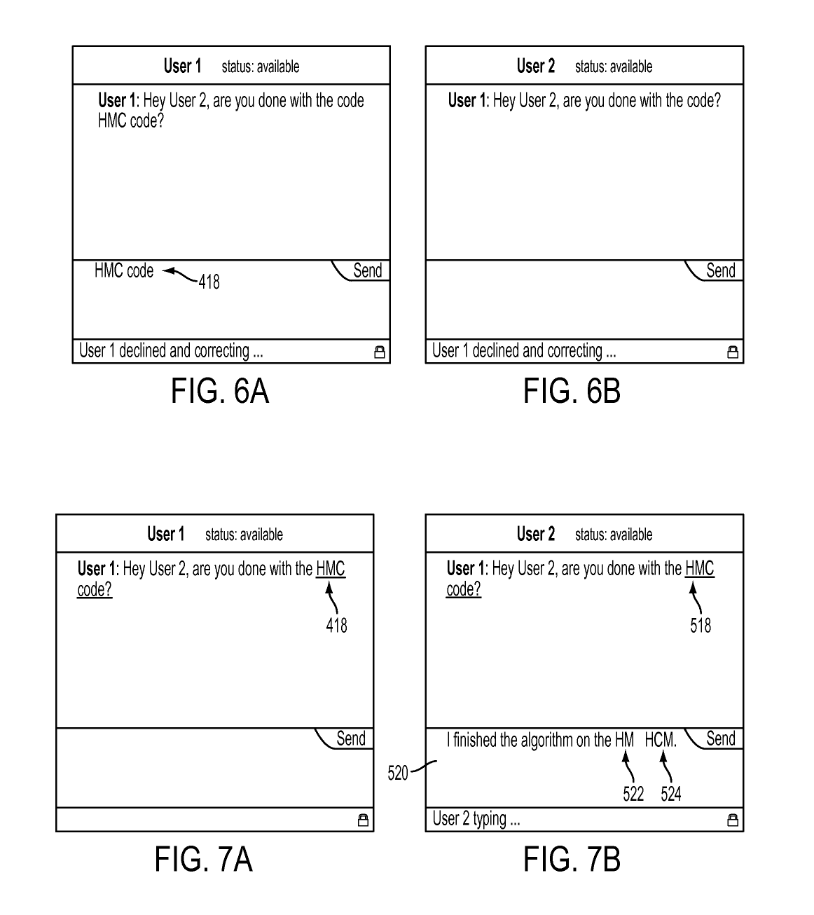

Referring now to FIGS. 6A and 6B, exemplary embodiments of a messaging application utilizing recipient auto-correction feedback being used are shown. FIG. 6A illustrates the messaging application 400 that is being used by a first user and FIG. 6B illustrates the messaging application 500 that is being used by a second user. As illustrated, if the first user selects to correct the proposed modification 416, as shown in FIG. 5A, the first user enters the corrected modification 418 in the message composition window 404. After entering the corrected modification 418 in the message composition window 404, the first user selects, or clicks on, the send button 406 to transmit the corrected modification 418 to the messaging application 500. As illustrated, the status indicators 408, 508 are configured to provide one user with an indication of an action being taken by the other user. For example, the status indicators 408, 508 indicate that the first user has declined the proposed modification and is correcting the proposed modification.

Referring now to FIGS. 7A and 7B, exemplary embodiments of a messaging application utilizing recipient auto-correction feedback being used are shown.

FIG. 7A illustrates the messaging application 400 that is being used by a first user and FIG. 7B illustrates the messaging application 500 that is being used by a second user. As illustrated, the second user is composing a message 520 to the first user in the message composition window 504 and the auto-correction function of the messaging application 500 has automatically changed a portion 522 of the message with a replacement portion 524.

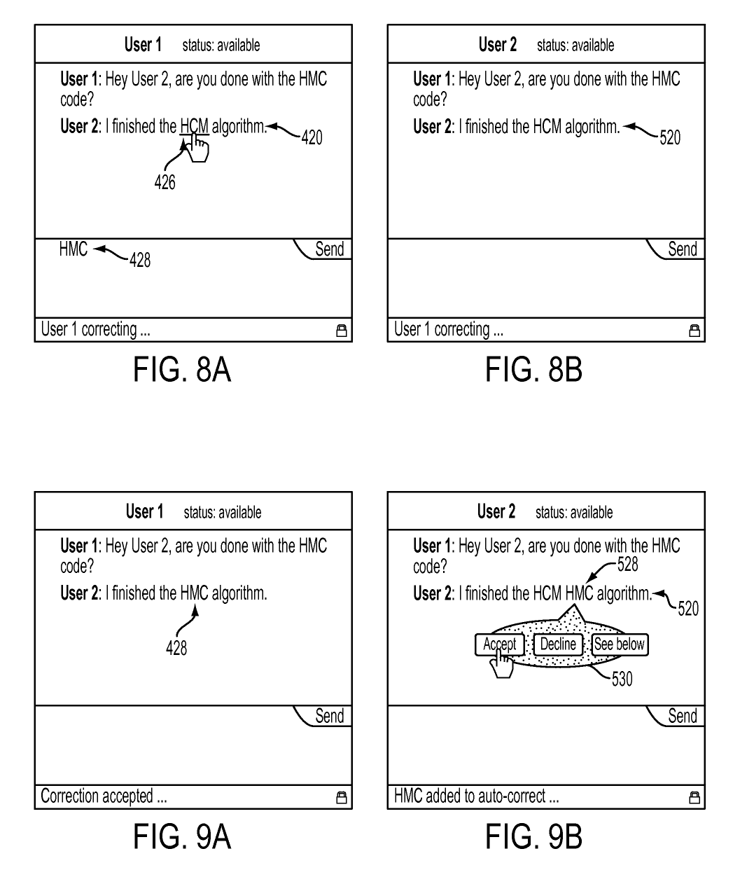

Referring now to FIGS. 8A and 8B, exemplary embodiments of a messaging application utilizing recipient auto-correction feedback being used are shown. FIG. 8A illustrates the messaging application 400 that is being used by a first user and FIG. 8B illustrates the messaging application 500 that is being used by a second user. As illustrated, the message 420 is displayed in the transcript window 402 of the messaging application 400. The first user selects a portion 426 of the message 420 for modification and enters a proposed modification in the message composition window 404. The first user then presses the send button 406 to transmit the proposed modification 428 to the first user. As illustrated, the status indicators 408, 508 are configured to provide one user with an indication of an action being taken by the other user. For example, the status indicators 408, 508 indicate that the first user is making a proposed modification to the message.

Referring now to FIGS. 9A and 9B, exemplary embodiments of a messaging application utilizing recipient auto-correction feedback being used are shown. FIG. 9A illustrates the messaging application 400 that is being used by a first user and FIG. 9B illustrates the messaging application 500 that is being used by a second user. In exemplary embodiments, after the messaging application 500 receives the proposed modification 528, an indication of the proposed modification 528 may be displayed in the message 520 to the second user. For example, the proposed modification 528 may be displayed as part of the message 520 as having a different font, such as a different color or different format (e.g., italicized or underlined). Likewise, the proposed modification 528 may be displayed as part of the message 520 as having a different font, such as a different color or different format (e.g., italicized or underlined). In exemplary embodiments, an icon 530 configured to allow the second user to accept, decline, or correct the proposed modification 528 is displayed to the second user. In one embodiment, the icon 530 is displayed to the second user after the second user selects, or clicks ok, the proposed modification 528. As illustrated, the status indicators 408, 508 are configured to provide one user with an indication of an action being taken by the other user. For example, the status indicators 408, 508 indicate that the second user is reviewing the proposed modification.

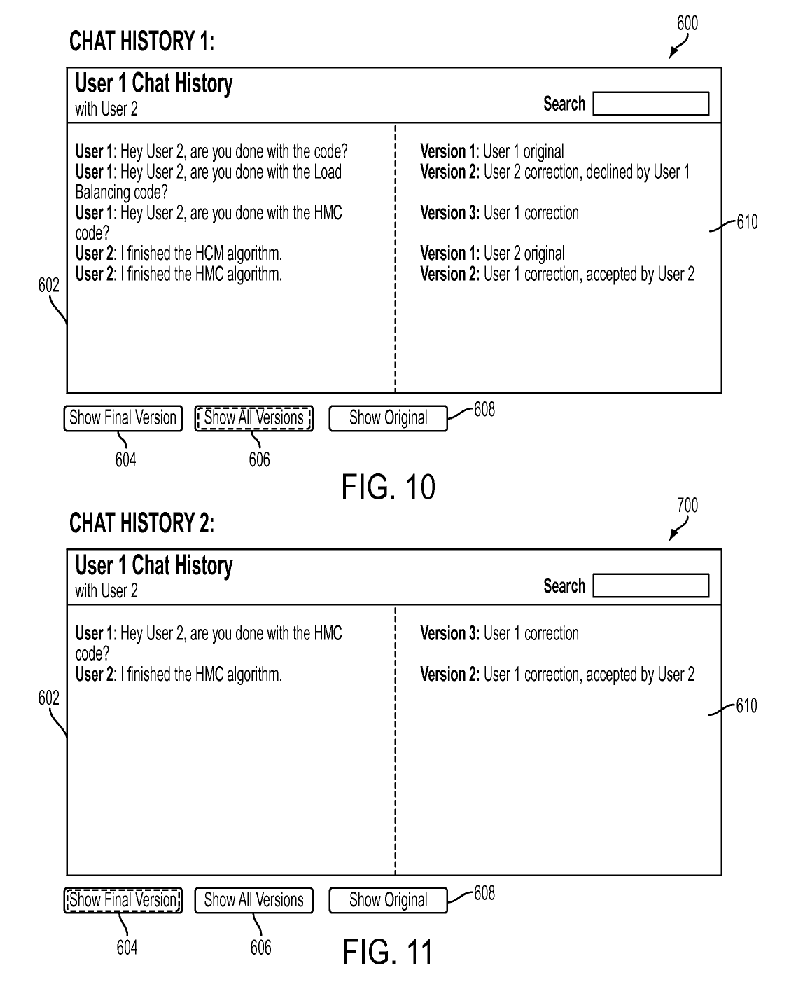

FIG. 10 is an illustration of a messaging application 600 utilizing recipient auto-correction feedback in accordance with an exemplary embodiment. As illustrated, the messaging application 600 includes a transcript window 602 configured to display messages exchanged between two users, also referred to as a chat history. In exemplary embodiments, the messaging application 600 includes buttons that allow the chat history to be displayed in the transcript window 602 in various formats. As illustrated, the show all versions button 603 causes the chat history to be displayed with all messages exchanged, including the messages that were subsequently modified. In exemplary embodiments, history window 610 may also be displayed that lists the status of each message in the transcript window 602.

FIG. 11 is an illustration of a messaging application 700 utilizing recipient auto-correction feedback in accordance with an exemplary embodiment. As illustrated, the messaging application 700 includes a transcript window 602 configured to display messages exchanged between two users, also referred to as a chat history. In exemplary embodiments, the messaging application 600 includes buttons that allow the chat history to be displayed in the transcript window 602 in various formats. As illustrated, the final version button 604 causes the chat history to be displayed with all modifications that were made by the users. In exemplary embodiments, history window 610 may also be displayed that lists the status of each message in the transcript window 602.

In exemplary embodiments, the auto-correction system includes auto correction databases that are located on both the sender's device and the receiver's device. In one embodiment, the sender's device receives feedback from the receiver's device regarding corrections made by the receiver, which may also be confirmed by the sender. In exemplary embodiments, the sender's device may update its auto correction database based on the corrections received from the sender. In addition, the sender may also provide the correction received from the receiver in a suggested correction that can be made available to other receivers. In exemplary embodiments, the sender may store and apply the feedback received on a per-receiver basis such that automatic corrections are customized based on the receiver's prior automatic corrections.

In exemplary embodiments, when a receiver receives a message including an error or typographical error, the receiver can often infer from context the intended message. For example, if a sender types a message “Where afe you” while intending to type “are” instead of “afe”. In this case, the sender's auto correction software may incorrectly replace “afe” with “ate.” When the received receives the message, he can infer that the sender meant to type “are” instead of “ate.” In exemplary embodiments, in addition to replying “I'm at work” the receiver can correct the sender's message. In one embodiment, if the receiver taps on the word, “ate,” the original misspelling and the two candidate words that auto-correction chose are displayed to the receiver. The receiver can then select a word from this sub-menu to quickly make the correction. The correction would then be sent to the sender, who would see the receiver's reply and a minimally intrusive marker under the word that the receiver has corrected. In exemplary embodiments, the correction feedback can influence automatic corrections that the sender's phone makes in the future. For example, if the sender makes a similar mistake while trying to type “Where are you”, the phone will correctly fix the typo to “are” instead of “ate”.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method for providing auto-correction feedback in a messaging application comprising:
receiving, by a processor, a message from a sender;
selecting a portion of the message for clarification;
creating a proposed modification to the message;
transmitting the proposed modification to the message to the sender; and
receiving a response from the sender regarding the proposed modification.

2. The method of claim 1, wherein the response indicates if the sender has accepted, rejected, or further modified the proposed modification.

3. The method of claim 1, wherein the messaging application is a short message service messaging application.

4. The method of claim 1, wherein the messaging application is an instant messaging application.

5. The method of claim 1, wherein the portion of the message is an acronym.

6. An article of manufacture tangibly embodying computer readable instructions which, when implemented, cause a computer to carry out the steps of a method according to claim 1.

7. An electronic device having a processor configured to execute the messaging application by carrying out the steps of a method according to claim 1.

8. A method for receiving auto-correction feedback in a messaging application comprising:
transmitting a message to a receiver;
receiving a proposed modification to a portion of the message from the receiver determining whether the proposed modification was accepted;
based on a determination that the proposed modification was accepted, transmitting a notification of acceptance of the proposed modification to the receiver; and
based on a determination that the proposed modification was not accepted, transmitting a notification of decline of the proposed modification to the receiver.

9. The method of claim 8, further comprising based on a determination that the proposed modification was accepted, updating an auto-correction database based on the proposed modification.

10. The method of claim 9, wherein updating the auto-correction database includes storing and applying the proposed modification received on a per-receiver basis such that automatic corrections are customized based on the receiver's prior proposed modification.

11. The method of claim 9, wherein updating the auto-correction database includes storing and applying the proposed modification to future automatic corrections for all receivers.

12. The method of claim 8, wherein the messaging application is a short message service messaging application.

13. The method of claim 8, wherein the messaging application is an instant messaging application.

14. An article of manufacture tangibly embodying computer readable instructions which, when implemented, cause a computer to carry out the steps of a method according to claim 8.

15. An electronic device having a processor configured to execute the messaging application by carrying out the steps of a method according to claim 8.
